(19) United States
(12) Patent Application Publication
(10) Pub. No.: US 2004/0018004 A1
(43) Pub. Date: Jan. 29, 2004

(54) Audio recording and playback device

(76) Inventor: Koji Mizobuchi, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 10/425,183

(22) Filed: Apr. 29, 2003

(30) Foreign Application Priority Data
May 10, 2002 (JP) 2002-136336

(51) Int. Cl. H04N 5/76; H04N 5/225

(52) U.S. Cl. 386/96; 386/117

(57) ABSTRACT

According to the present invention, an audio recording and playback device operates in such a manner that when a playback instruction member to instruct playback of data is operated during the selection of an audio storage area by a system control unit, audio data selected by an operation unit is played back and an image related to the audio data selected by the operation unit is played back. When the playback instruction member is operated during the selection of an image storage area by the system control unit, only image data selected by the operation unit is played back.

This application claims benefit of Japanese Application No. 2002-136336 filed in Japan on May 10, 2002, the contents of which are incorporated by this reference.

### BACKGROUND OF THE INVENTION

1. Field of the Invention

The present invention relates to an audio recording and playback device and, more particularly, to an audio recording and playback device having an imaging function.

2. Related Art Statement

As is well known, portable audio recording and playback devices have been put into practical use. This kind of portable audio recording and playback device converts an audio signal into digital data, stores the digital data in a flash memory serving as a rewritable storage medium, converts the audio data stored in the flash memory into an analog audio signal, and then plays back the audio signal.

As the characteristics of the above audio recording and playback device, various operation modes such as recording, playback, fast-forward, and fast-rewind can be selectively operated by controlling predetermined switches. For example, when the recording mode is selected, audio data converted to a digital signal is stored in an audio data area and index information (the address of this audio data, recording date and time, and the like) regarding the audio data is stored in an index information area, these areas being previously formed in the flash memory.

A file number and a folder mark are assigned to audio data stored in the flash memory. Thus, file retrieval or playback is easily performed later. As for the folder, in order to efficiently categorize and manage files which will be increased every recording time, a plurality of folders, for example, folders A, B, and C are generally formed. The audio recording and playback device is designed so as to pop up the folder mark in a display such as an LCD on the device body so that a speaking person (speaker) easily recognizes the folder which is being selected.

On the other hand, for the audio recording and playback device with a camera having an image recording function, the device records image data upon shooting in addition to audio data. A formed image data file is stored in a folder exclusively used for image data files in order to avoid confusion with an audio data file. In other words, the image data file is managed using an exclusive folder mark. For example, when it is assumed that the folders A, B, and C are exclusive to audio data files as mentioned above, a folder P is added as a folder exclusively used for image data files.

When the speaker actually confirms the content of the folder while watching the LCD, in many cases, he or she checks the number of files and simultaneously checks the recording state (playback sound) of the file because the speaker uses the audio recording and playback device. At this time, when the speaker operates a playback switch without noticing that he or she selects the folder exclusively used for image data, playback of meaningless sounds is started because the encoding format of audio data is different from that of image data.

### SUMMARY OF THE INVENTION

According to the present invention, in brief, there is provided an audio recording and playback device including:

a storage unit having an audio storage area in which audio data is recorded and an image storage area in which image data is recorded;

a first selection unit for selecting the audio storage area or the image area;

a second selection unit for selecting audio data or image data stored in the storage unit;

a playback instruction member for instructing playback of the audio data or image data selected by the second selection unit;

an audio playback unit for playing back the audio data selected by the second selection unit;

a display unit for playing back and displaying the image data selected by the second selection unit; and

a control unit for controlling so that the audio data selected by the second selection unit is played back and an image related to the audio data selected by the second selection unit is played back when the playback instruction member is operated during the selection of the audio storage area by the first selection unit, and controlling so that only the image data selected by the second selection unit is played back when the playback instruction member is operated during the selection of the image storage area by the first selection unit.

### BRIEF DESCRIPTION OF THE DRAWINGS

FIG. 1 is a block diagram schematically showing the structure of an audio recording and playback device according to an embodiment of the present invention;

FIG. 2 is a block diagram showing the concrete structure of the audio recording and playback device according to the embodiment;

FIG. 3 is a flowchart schematically showing a process of the main operation of the audio recording and playback device according to the embodiment;

FIG. 4 is a flowchart explaining a standby mode in FIG. 3 in detail;

FIG. 5 is a diagram showing the structure of an audio data area and that of an index information area and the relationship therebetween, the areas being stored in a storage unit in FIG. 2;

FIG. 6 is a flowchart explaining a recording process in FIG. 3 in detail;

FIG. 7 is a flowchart explaining an image capture process in FIG. 6 in detail;

FIG. 8 is a flowchart explaining a playback process in FIG. 3 in detail;

FIG. 9 is a flowchart explaining an image playback process in FIG. 8 in detail;

FIG. 10 is a top view of the arrangement of essential parts of the audio recording and playback device according to the embodiment, FIG. 10 schematically showing a shooting state upon recording;

FIG. 11 is a front view of the arrangement of essential parts of the audio recording and playback device according to the embodiment, FIG. 11 schematically showing a shooting state upon recording;

FIG. 12 is a front view of the arrangement of essential parts of the audio recording and playback device according to the embodiment, FIG. 12 schematically showing a shooting state upon recording; and

FIG. 13 is a front view of the audio recording and playback device according to the embodiment, FIG. 13 schematically showing an image playback state upon playback.

### DETAILED DESCRIPTION OF THE PREFERRED EMBODIMENTS

An embodiment of the present invention will now be described hereinbelow with reference to the drawings.

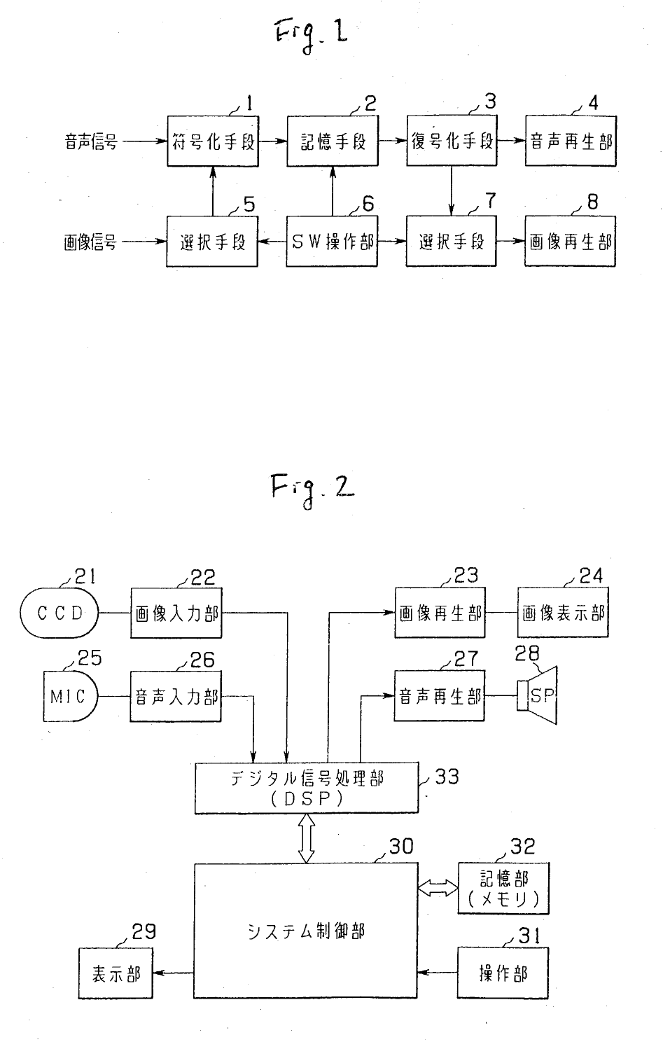

FIG. 1 shows a block diagram schematically showing the structure of an audio recording and playback device according to the embodiment of the present invention.

As shown in FIG. 1, the audio recording and playback device of the present embodiment comprises encoding means 1 for encoding an audio signal and an image signal to audio data and image data according to respective predetermined formats, an SW operation unit 6 having a plurality of control switches, selection means 5 for operating a specified switch of the SW operation unit 6 only during audio recording to input image data to the encoding means 1, storage means 2 for storing the audio data and image data related to the audio data, decoding means 3 for decoding the audio data and the image data read from the storing means 2 to an audio signal and an image signal according to respective predetermined decoding formats upon playback, an audio playback unit 4 for playing back the decoded audio signal as a sound, an image playback unit 8 for playing back the decoded image signal as an image, and selection means 7 for selectively outputting an image signal alone, related to the audio signal, to the image playback unit 8.

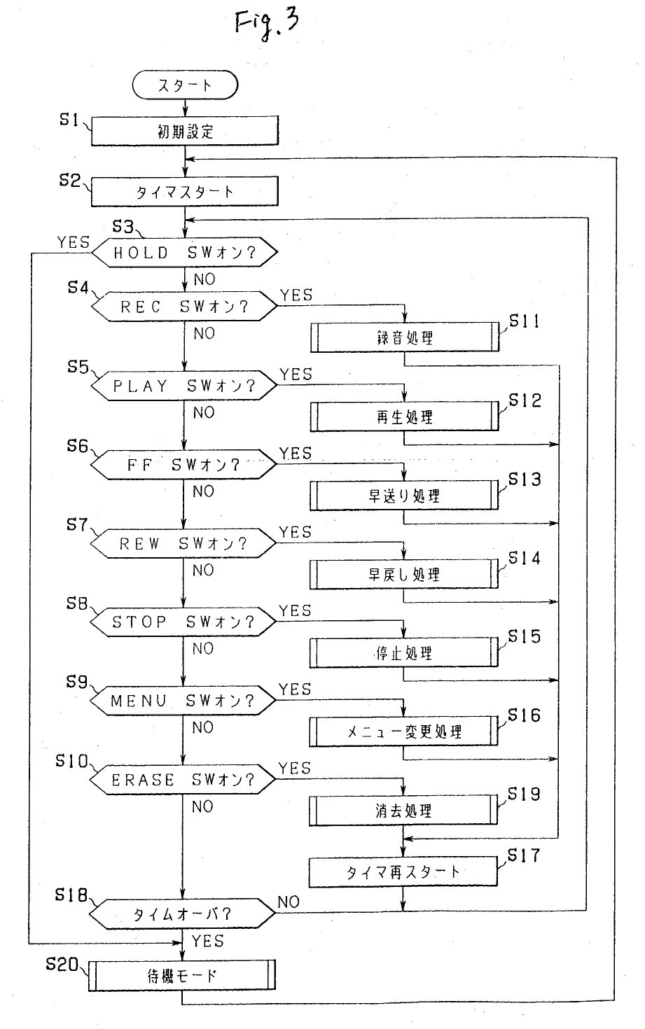

FIG. 2 is a block diagram showing the concrete structure of the audio recording and playback device according to this embodiment.

Referring to FIG. 2, an output terminal of a microphone (MIC) 25, which converts a sound into an electric signal, is connected to an input terminal of an audio input unit 26. An output terminal of the audio input unit 26 is connected to an input terminal of a digital signal processing unit (DSP) 33.

Further, an output terminal of the digital signal processing unit (DSP) 33 is connected to an input terminal of an audio playback unit 27. An output terminal of the audio playback unit 27 is connected to an input terminal of a speaker (SP) 28.

Similarly, an output terminal of an imaging device (CCD) 21, which converts an image into an electric signal, is connected to an input terminal of an image input unit 22. An output terminal of the image input unit 22 is connected to the input terminal of the digital signal processing unit 33.

Further, the output terminal of the digital signal processing unit 33 is connected to an input terminal of an image playback unit 23. An output terminal of the image playback unit 23 is connected to an input terminal of an image display unit 24 comprising, for example, a TFT type LCD. The image display unit 24 includes display means for playing back and displaying image data selected by second selection means, which will be described later, and displaying attribute information of audio data or image data selected by data selection means, which will be described later.

The audio input unit 26 comprises a microphone amplifier for amplifying an electric signal supplied from the microphone 25, a low-pass filter for cutting an unnecessary frequency band, and an A/D converter for converting an input audio signal (analog signal) into a digital signal, these components being not shown in the diagram.

The audio playback unit 27 comprises a D/A converter for converting an input digital signal into an analog signal, a low-pass filter for cutting an unnecessary frequency band, and a power amplifier for amplifying an audio signal, these components being not shown in the diagram. The audio playback unit 27 includes audio playback means for playing back audio data selected by the second selection means, which will be described later, and playing back audio data designated by first selection means, which will be described later.

The image input unit 22 comprises various circuits for controlling iris, gain, and white balance, and an A/D converter, these components being not shown in the diagram. The image input unit 22 converts various pixel signals supplied from the imaging device 21 into digital signals.

The image playback unit 23 comprises a video control circuit and a D/A converter, these components being not shown in the diagram. In the image playback unit 23, an input digital signal is converted into an analog signal.

The digital signal processing unit (DSP) 33 is controlled by a system control unit 30, which will be described later. Upon recording, the digital signal processing unit 33 encodes (compresses) audio and image digital signals to audio data and image data in the respective predetermined encoding formats every frame. The encoded data is temporarily stored in a buffer memory (not shown) of the system control unit 30. Upon playback, the digital signal processing unit 33 decodes (decompresses) audio data and image data from the buffer memory every frame.

The digital signal processing unit (DSP) 33 is connected to the system control unit 30. In addition to the digital signal processing unit 33, a storage unit (memory) 32, an operation unit 31, and a display unit 29 are connected to the system control unit 30.

The system control unit 30 comprises, for example, a CPU and controls the whole of the present device. The system control unit 30 comprises control means according to the present invention, playback instruction means for instructing playback of audio data selected by folder selection means, which will be described later, warning means for warning that playback of audio data is forbidden, forbidding means for forbidding playback of audio data when the image folder is selected by the folder selection means, which will be described later, and the first selection means for selecting an audio storage area or an image area, which will be described later.

The storage unit (memory) 32 comprises a nonvolatile semiconductor memory such as a flash memory. Upon recording, the storage unit 32 stores audio data and image data, encoded by the digital signal processing unit 33, through the buffer memory (not shown) of the system control unit 30. At this time, the storage unit 32 also stores index information regarding audio data and image data. The storage unit 32 has an audio storage area in which audio data is recorded and an image storage area in which image data is recorded, and also includes storage means having an audio folder to store a plurality of audio data and an image folder to store a plurality of image data.

The operation unit 31 includes control switches for controlling various functions. Namely, the operation unit 31 comprises a recording switch (REC), a playback switch (PLAY), a stop switch (STOP), a fast-forward switch (FF), a fast-rewind switch (REW), a menu switch (MENU), a hold switch (HOLD), and an erasing switch (ERASE). The operation unit 31 comprises the second selection means for selecting audio data or image data stored in the storage means, the folder selection means for selecting the audio folder or the image folder, and data selection means for selecting audio data to be played back among the audio data stored in the audio folder or image data to be played back among the image data stored in the image folder, the folder being selected by the folder selection means.

The display unit 29 displays an operation mode indicated when a predetermined sequence operation is started by operating any switch of the operation unit 31, or a situation of the subsequent operation. For example, when the recording switch (REC) is pressed, the display unit 29 displays a recording elapsed time, a recordable remaining time, and a file number. When the menu switch (MENU) is pressed, the display unit 29 displays information related to the selection of functions, for example, the sensitivity of the microphone (high/low), a recording mode (standard/long), and an alarm (on/off). Further, when the system control unit 30 has a clock function, the display unit 29 displays the current date and time. The above information can also be displayed in the image display unit 24.

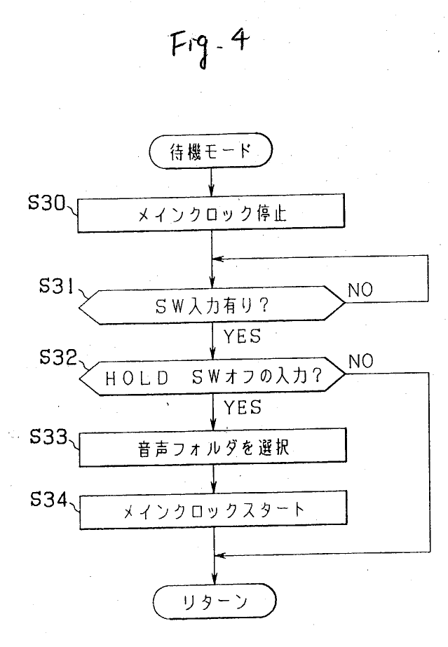

The operation of the audio recording and playback device according to the present embodiment will now be described with reference to FIG. 3.

FIG. 3 is a flowchart schematically showing a process of the main operation of the audio recording and playback device according to the embodiment.

As shown in the flowchart, when the audio recording and playback device is turned on, the system control unit 30 in FIG. 2 performs predetermined initialization in step S1 and then proceeds the operation to step S2. A timer is started in step S2. Then, the operation proceeds to step S3.

The timer is used to clock an elapsed time until the audio recording and playback device in the normal operation mode enters a standby mode (low current consumption mode).

When the audio recording and playback device enters the operation mode, in steps S3 to S10, the system control unit 30 sequentially detects whether each of the switches of the control unit 31 is on in the order of the hold switch (HOLD), the recording switch (REC), the playback switch (PLAY), the fast-forward switch (FF), the fast-rewind switch (REW), the stop switch (STOP), the menu switch (MENU), and the erasing switch (ERASE). Each time it is detected that the switch is on, the operation branches from each of the respective steps to each of the corresponding steps S20, S11, S12, S13, S14, S15, S16, and S19, thus executing each of predetermined subroutines such as “standby mode”, “recording process”, “playback process”, “fast-forward process”, “fast-rewind process”, “stop process”, “menu change process”, and “erasing process”.

After executing each of the subroutines other than “standby mode”, the system control unit 30 restarts the timer in step S17 and then returns the operation to the main loop.

Various processes such as the fast-forward process, fast-rewind process, stop process, menu change process, and erasing process are performed by well-known techniques. Since these processes are not directly concerned with the content of the present invention, the detailed description thereof is omitted.

When all of the switches are off in steps S3 to S10, the system control unit 30 proceeds the operation to step S18 and then determines whether the timer exceeds a predetermined elapsed time. If the timer does not exceeds the predetermined elapsed time, the operation returns to step S3 of the main flow. If the timer exceeds the predetermined elapsed time, the process proceeds to step S20 in the same way as the case where the HOLD SW is turned on in step S3 mentioned above, thus entering a subroutine of the standby mode. Consequently, the device enters the low current consumption mode.

Specifically speaking, the power to the audio input unit 26, the image input unit 22, the audio playback unit 27, the image playback unit 23, the image display unit 24, the digital signal processing unit (DSP) 33, the display unit 29, and the storage unit 32 in FIG. 2 is cut off. Alternatively, the system control unit 30 outputs a non-selection signal to a chip enable terminal provided for an IC (not shown) constituting each of these components. Thus, the device enters the low current consumption mode.

At this time, the system control unit 30 (CPU) changes its own operation clock to a low-speed clock having the minimum current consumption, thus entering the low current consumption mode. The operation clock can be changed from a main clock (for example, 9.28 MHz) to a sub clock (for example, 37.768 kHz) as necessary. The main clock can be completely stopped until the turn-on of any switch is detected. In the standby mode, when any of the switches is operated, the operation clock is again changed to the main clock. The operation is returned to step S2.

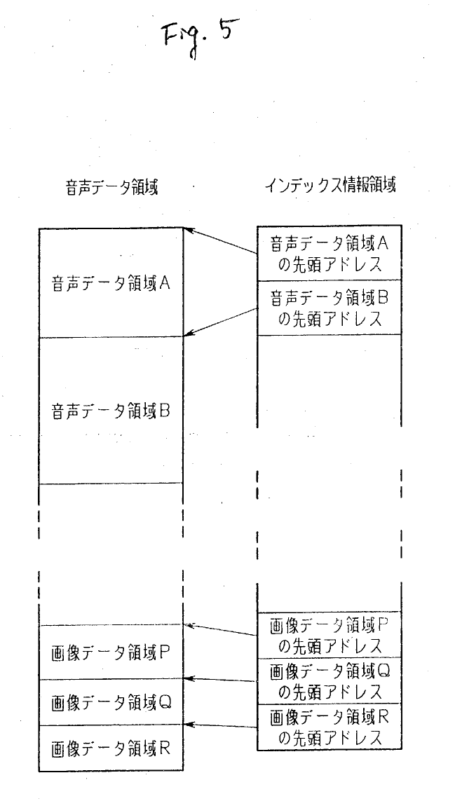

Next, the “standby mode” in step S20 of the above predetermined subroutines will now be described with reference to a flowchart of FIG. 4.

FIG. 4 is the flowchart explaining the standby mode in FIG. 3 in detail.

In the standby mode, the system control unit 30 first interrupts the main clock in step S30 and, in step S31, mainly detects whether any switch is turned on. When it is detected that any switch is turned on, the operation proceeds to step S32. The operation proceeds from the standby mode to step S2 in FIG. 3 mentioned above, thus starting the timer. Accordingly, the operation is returned to the main loop.

In the above detection of whether any switch is turned on, when detecting in step S32 that the hold switch is turned off, the system control unit 30 selects the audio folder in step S33 and then starts the main clock in step S34, thus returning the operation to the main loop.

Next, the “recording process” in step S11 of the predetermined subroutines in FIG. 3 will now be described with reference to a flowchart of FIG. 6 and FIGS. 2 and 5.

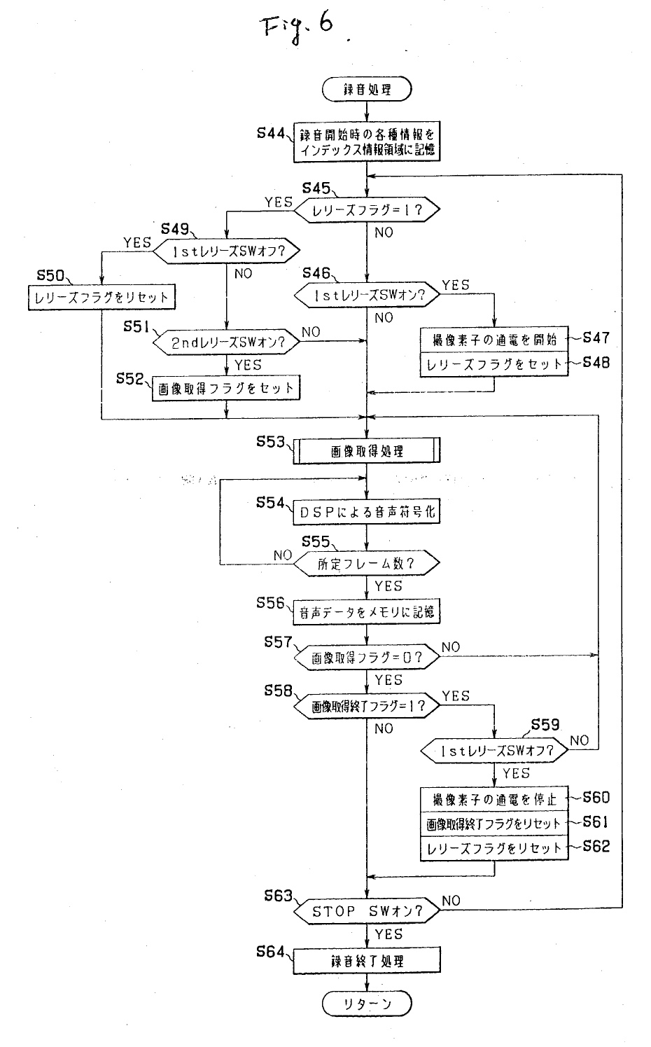

FIG. 5 shows the structure of an audio data area and that of an index information area and the relationship therebetween, the areas being stored in the storage unit 32 in FIG. 2. FIG. 6 is the flowchart explaining the recording process in FIG. 3 in detail.

In FIG. 6, when recording is started, under the control of the system control unit 30, in step S44, various information, for example, the sensitivity of the microphone (high/low), the recording mode (standard/long), a file number, and the head address of an audio data storage area to store this audio data are first stored in the index information area in the storage unit 32. Then, the process proceeds to step S45.

The system control unit 30 detects a release flag in step S45. If a release flag is set in step S48, which will be described later, the system control unit 30 branches the process to step S49 and then detects the state of a 1st release switch. At this time, if the 1st release switch is on, the process proceeds to step S51 and the state of a 2nd release switch is confirmed. If it is detected in S49 that the 1st release switch is off, the process branches to step S50. The release flag is reset in step S50.

If it is detected in step S51 that the 2nd release switch is on, the system control unit 30 proceeds the process to step S52 and then sets an image capture flag. After that, the process proceeds to step S53 and a subroutine of an image capture process is executed. The above-mentioned 1st and 2nd release switches are equivalent to release switches (REL), which will be described later.

If the release flag is not set in step S45 mentioned above, the system control unit 30 proceeds the process to step S46 and then determines whether the 1st release switch is on during recording. If the 1st release switch is on, the process branches to step S47 and the application of power to the imaging device is started. Then, the process proceeds to step S48 and the release flag is set. The process proceeds to step S53. The subroutine of the image capture process is executed.

If it is detected in step S46 that the 1st release switch is off, the system control unit 30 advances the process to step S53 and executes the subroutine of image processing.

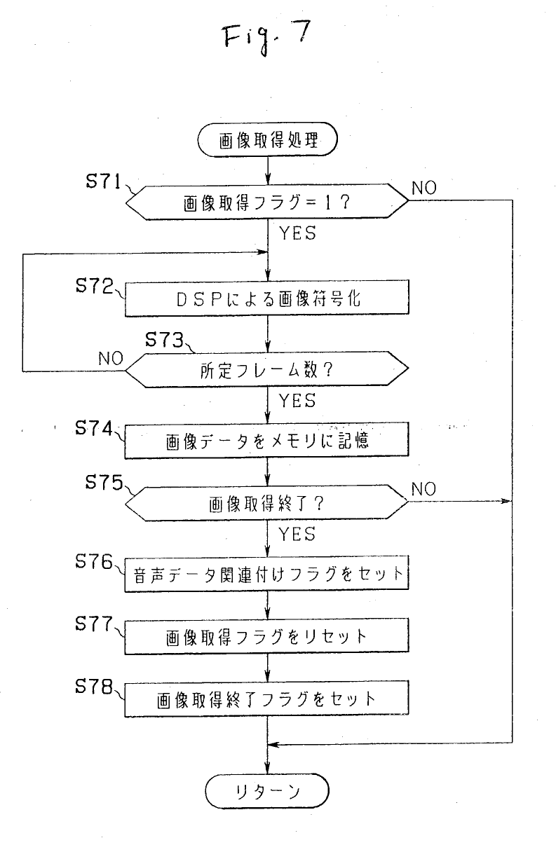

The subroutine of the image capture process in step S53 will be described in detail hereinafter with reference to FIG. 7, which will be described later.

In step S53, the subroutine of the image capture process is executed. After that, the process proceeds to step S54 and an audio signal is encoded by the digital signal processing unit 33. Encoding is performed every frame. Accordingly, encoding is continuously performed until the number of frames of audio data reaches a predetermined number of frames.

In step S55, the system control unit 30 determines whether the number of frames of audio data, stored in the buffer memory (not shown) of the system control unit 30, reaches the predetermined number of frames. When the number of frames of audio data reaches the predetermined number, the process proceeds to step S56. The audio data is stored so that the audio data is sequentially recorded in the order from the start address of the audio data storage area of the storage unit 32. For example, when audio data obtained by encoding an audio signal of 10 bits/frame to data of 4 bits/frame is written to the storage unit 32 every 512 bytes, the predetermined number of frames is 1024.

As shown in FIG. 5, audio data stored in the storage unit 32 is stored so that an audio data area A and an audio data area B are sequentially stored in the order from, for example, the head address of the audio data area. A start address corresponding to the audio data area A and that corresponding to the audio data area B are stored as the head address of the audio data area A and that of the audio data area B in the index information area. Each time an audio data area is allocated as an audio data area C, an audio data area D, . . . , the head address of each audio data area is stored in the index information area. After the audio data is stored in the storage unit 32, the process proceeds to step S57.

In step S57, the system control unit 30 determines whether the image capture flag is reset. If the image capture flag is reset, encoding of the audio signal and encoding of an image signal, which will be described later, are simultaneously performed by the digital signal processing unit 33. In other words, audio data and image data are alternately stored in the storage unit 32 every predetermined number of frames so that a sound interruption is not caused during shooting.

If the image capture flag is not reset in step S57, the system control unit 30 returns the process to step S53 and repeats the subroutine of the image capture process.

After image capture is completed, the system control unit 30 advances the process to step S58. The system control unit 30 determines whether an image capture termination flag is set and also continues encoding of audio signals. If the image capture termination flag is set, the process branches to step S59. The state of the 1st release switch is detected. If it is detected that the 1st release switch is off, the application of power to the imaging device is interrupted in step S60, the image capture termination flag is reset in S61, and the release flag is reset in step S62.

If the 1st release switch is on in step S59, the system control unit 30 returns the process to step S53 and repeats the subroutine of the image capture process.

Steps S45 to S62 are repetitively executed in accordance with the predetermined release sequence operation until the stop switch (STOP) is turned on in step S63. When the stop switch (STOP) is turned on, the system control unit 30 advances the process to step S64 and executes a recording termination process to terminate the recording. Then, the process is returned.

Next, the “image capture process” in step S53 of the predetermined subroutines will now be described with reference to a flowchart of FIG. 7, and FIGS. 2 and 5.

FIG. 7 is the flowchart explaining the image capture process in FIG. 6 in detail.

In step S71, the system control unit 30 first detects whether the image capture flag is set. If the flag is not set, the normal recording process is executed. If the flag is set, the shooting operation is performed. Accordingly, the process proceeds to step S72. The system control unit 30 controls the digital signal processing unit 33 to encode a captured image signal. Encoding is performed every frame in the same way as the case of audio data. Encoding is continued until the number of frames of image data reaches a predetermined number of frames.

Subsequently, in step S73, the system control unit 30 determines whether the number of frames of image data, stored in the buffer memory (not shown) of the system control unit 30, reaches the predetermined number. If YES, the process proceeds to step S74. The image data is stored so that the image data is sequentially written in the order from the start address of the image data storage area of the storage unit 32.

For image data stored in the storage unit 32, as shown in FIG. 5, the start address of the image data area is sequentially stored at, for example, the final address of the audio data area. A start address corresponding to an image data area P, that corresponding to an image data area Q, and that corresponding to an image data area R are stored in the index information area as the head address of the image data area P, that of the image data area Q, and that of the image data area R, respectively.

In the same way as the case of the above-mentioned audio data, image data is also stored in such a manner that each time an image data area is allocated, the head address of the image data area is stored in the index information area.

Steps S71 to S74 are repetitively performed until image capture is completed. After the image capture is completed in step S75, the system control unit 30 sets an audio data association flag in step S76 and then resets the image capture flag in step S77. Subsequently, the system control unit 30 sets the image capture termination flag in step S78 to terminate the present subroutine. When determining in step S75 that the image capture is not completed, the system control unit 30 returns the process to the main routine.

Resetting of the image capture flag in step S77 and setting of the image capture termination flag in step S77 correspond to steps S57 and S58 in FIG. 6, respectively.

The audio data association flag will be described in detail in the image playback process, which will be explained hereinbelow.

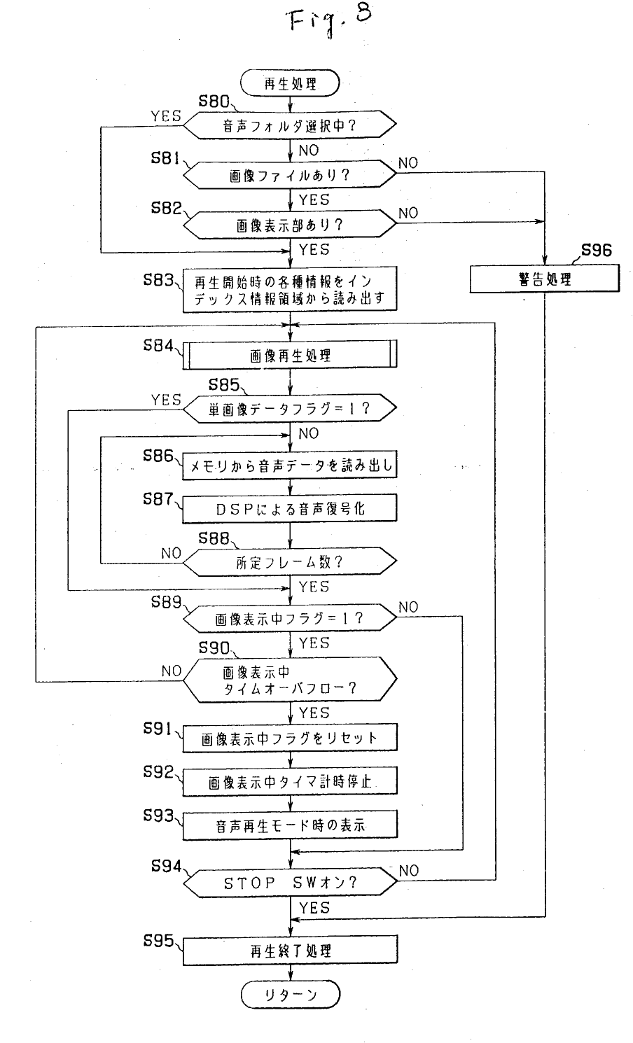

Next, the “playback process” in step S12 in FIG. 3 will now be described with reference to a flowchart of FIG. 8 and FIG. 2.

FIG. 8 is the flowchart explaining the playback process in FIG. 3 in detail.

When audio playback is started, in step S80, the system control unit 30 first determines whether the audio folder is selected. If the audio folder is selected, the system control unit 30 skips the process to step S83. In step S83, various information, for example, the recording mode (standard/long) related to the selected audio data area, a file number, and the start address of the audio data storage area, in which the audio data is stored, are read from the index information area of the storage unit 32. After step S83, the system control unit 30 proceeds the process to step S84.

In step S84, the system control unit 30 executes a subroutine of an image playback process. After that, in step S85, the system control unit 30 detects whether a single image data flag, which will be described later, is set. If the flag is not set, in step S86, the system control unit 30 sequentially reads audio data stored in the storage unit 32 in the order from the start address of the audio data storage area. In step S87, the system control unit 30 controls the digital signal processing unit 33 to decode the audio data. In this instance, decoding is performed every frame. Decoding is continuously performed until the number of frames of the audio data reaches the predetermined number of frames. While sequentially storing the audio data in the buffer memory (not shown) of the system control unit 30, the system control unit 30 outputs the data as audio signals to the audio playback unit 27.

After the audio data is decoded by the predetermined number of frames in step S88, the system control unit 30 detects the state of an image displaying flag in step S89. If the image displaying flag is set, the display unit 29 in FIG. 2 displays an image simultaneously with the start of audio playback. Then, the process proceeds to step S90. A speaking person (speaker) is recognized in association with audio playback. Generally, speaker recognition is sufficiently performed for several seconds after the start of image display. Accordingly, in step S90, the system control unit 30 determines whether an image displaying timer, which starts clocking in the image playback process, exceeds a predetermined elapsed time. The image playback process will be described later. If the timer does not exceed the predetermined elapsed time, steps S84 to S89 are repetitively performed.

If the timer exceeds the predetermined elapsed time in step S90, the system control unit 30 proceeds the process to step S91 and resets the image displaying flag. In step S92, the system control unit 30 stops the image displaying timer from clocking. In step S93, the system control unit 30 allows to display information (a recording time, a playback elapsed time, a recording mode (standard/long), and a file number) of the normal playback mode.

Steps S84 to S89 are repetitively performed until the stop switch (STOP) is turned on in step S94. When the stop switch (STOP) is turned on, the system control unit 30 proceeds the process to step S95 and then executes a playback termination process. After playback is terminated, the process is returned.

In the determination of whether the audio folder is selected in step S80, if the image folder is selected, the system control unit 30 proceeds the process to step S81 and then determines whether the folder includes an image file. If any image file is not included, the system control unit 30 branches the process to step S96 and then performs a warning process. The system control unit 30 executes the playback termination process in step S95, thus terminating playback. For warning means of the warning process in step S96, for example, when an LED is blinked and a beep sound is used, a warning is more effectively given to the user.

On the other hand, if an image file exists in step S81, the system control unit 30 proceeds the process to step S82 and then determines whether an image display portion is included. If any image display portion is not included, the system control unit 30 branches the process to step S96 and then performs the warning process. In step S95, the system control unit 30 executes the playback termination process, thus terminating playback.

The image file in the image folder belongs to either of a file with an audio data association flag or a file with a single image data flag. In the image playback process in step S84 and the determination regarding the single image data flag in step S85, the system control unit 30 determines the attribute of the image file. If the single image data flag is set, steps S86 to S88 are skipped and only the image playback process in step S84 is executed.

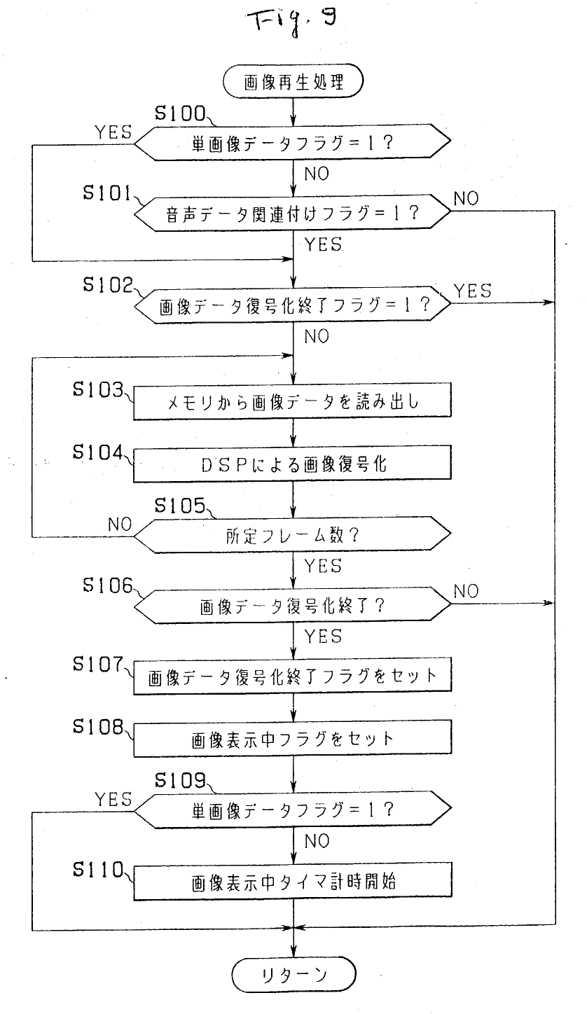

Next, the “image playback process” in step S84 of the above predetermined subroutines will now be described with reference to a flowchart of FIG. 9 and FIG. 2.

FIG. 9 is the flowchart explaining the image playback process in FIG. 8 in detail.

In step S100, the system control unit 30 first detects whether the single image data flag is set. If the flag is set, the system control unit 30 branches the process to an image decoding process in step S102. If the flag is not set, the system control unit 30 proceeds the process to step S101 and then detects whether an audio data association flag is set.

If the audio data association flag is not set in step S101, the system control unit 30 returns the process and then executes the normal playback process shown in FIG. 8 to decode only audio data. If the audio data association flag is set, the system control unit 30 proceeds the process to step S102. In step S102, the system control unit 30 detects whether an image data decoding termination flag is set. If the image data decoding termination flag is set, the process is returned. On the other hand, if the image data decoding termination flag is not set, in step S103, the system control unit 30 sequentially reads image data stored in the storage unit 32 from the start address of the image data storage area. Subsequently, in step S104, decoding is performed by the digital signal processing unit 33.

In this instance, decoding is performed every frame in a manner similar to the case of audio data. Accordingly, decoding is continuously performed until the number of frames of image data reaches the predetermined number of frames in step S105. While sequentially storing image data in the buffer memory (not shown) of the system control unit 30, the system control unit 30 outputs the data as image signals to the image playback unit 23.

Steps S101 to S105 are repetitively performed until decoding of the image data is terminated in step S106. In step S107, the system control unit 30 sets the image data decoding termination flag simultaneously with the termination of decoding of the image data. In step S108, the system control unit 30 sets the image displaying flag and, in step S110, starts clocking of the image displaying timer, thus terminating the process.

If the single image data flag is set in step S109, the system control unit 30 terminates the process without starting the clocking of the image displaying timer in step S110. In other words, in the case of image playback with no sound, image display is continued without a time limit so that it takes an enough time for a speaker to easily recognize an image.

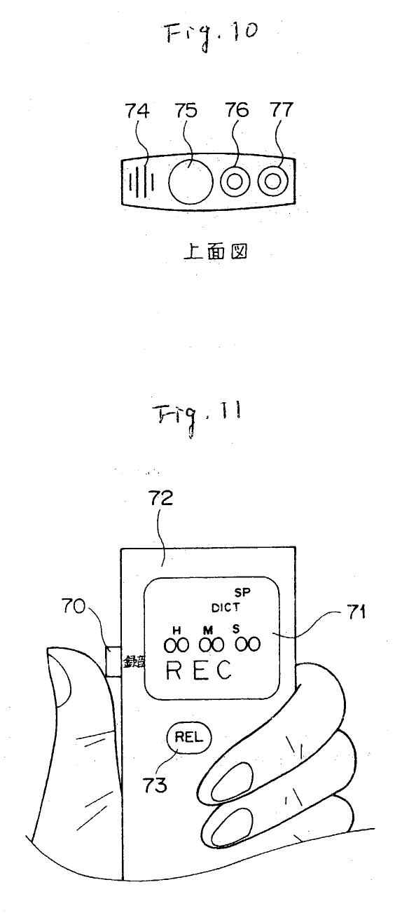

Next, the outline of an image capture method upon actual recording will now be described with reference to FIGS. 10, 11, and 12.

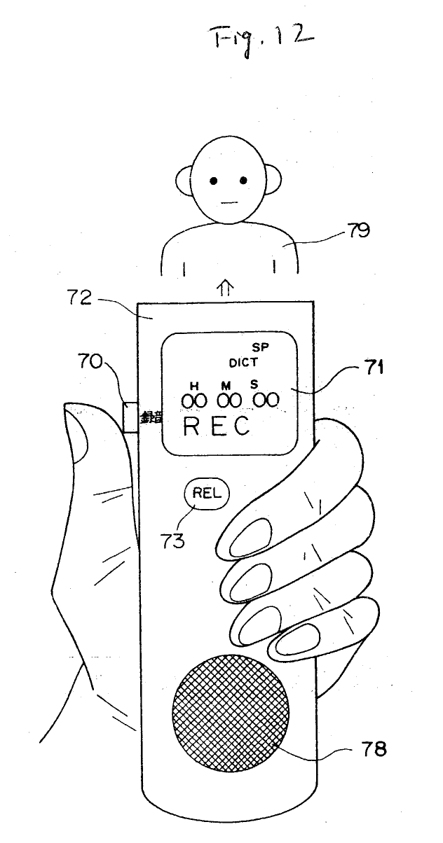

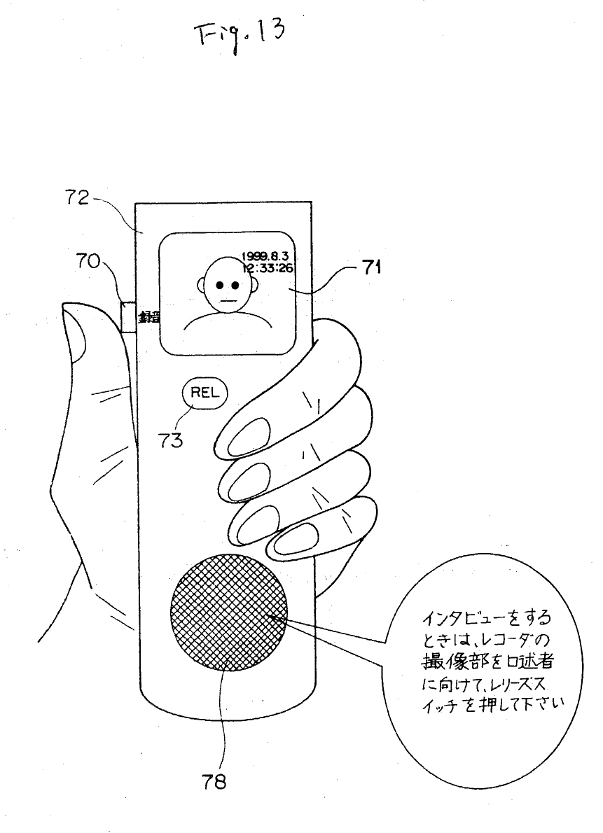

FIG. 10 is a top view of the audio recording and playback device according to the present embodiment, FIG. 10 schematically showing the shooting state thereof upon recording. FIG. 11 is a front view thereof. FIG. 12 shows a diagram showing the service conditions thereof.

On the top surface of an audio recording and playback device 72 mentioned above, microphone slits 74, an imaging lens 75, a microphone jack 76, and an earphone jack 77 are arranged in the longitudinal direction. The microphone 25 and the imaging device 21, shown in FIG. 2, are built in the device so as to correspond to the microphone slits 74 and the imaging lens 75, respectively.

A release switch button 73 and a display 71 are arranged in the upper portion on the front surface of the audio recording and playback device 72. A recording switch button 70 is arranged on one side surface thereof.

Other control switch buttons arranged on the audio recording and playback device 72 are not shown in the diagram. The control switch buttons are arranged on the front surface or at least one side surface of the audio recording and playback device 72 so that the user can easily control the switches.

Further, speaker holes 78 are arranged in the lower portion on the front surface of the audio recording and playback device 72. The speaker 28, shown in FIG. 2, is built in the device so as to correspond to the speaker holes 78. In many cases, light-touch switches, generally called tactile push switches, are used as the control switches.

The recording switch button 70 of the audio recording and playback device 72 is first pressed to turn on a recording switch, thus starting recording. At this time, the display 71 shows initial information indicating the recording start, thus notifying the operator of a recording mode. In this state, as shown in FIG. 12, the operator points the top surface of the audio recording and playback device 72 at a speaking person (speaker) 79 and presses the release switch button 73 to turn on a release switch. Thus, the image of the speaker can be captured. Image capture is performed each time the release switch is turned on. Accordingly, even when interviewing a plurality of speakers, the operator can certainly record the images of the speakers so as to correspond to respective speech contents.

Further, in order to certainly record an image, an image captured by the imaging lens 75 can be displayed on the display 71 for a while after the release switch is turned on. After framing of a subject is determined, the operator again presses the release switch, thus executing image capture.

The outline of image playback upon playback will now be described with reference to FIG. 13. FIG. 13 is a front view of the audio recording and playback device, FIG. 13 showing the outline of image playback upon playback.

A playback switch button (not shown) arranged on the front surface or the side surface of the audio recording and playback device 72 is pressed to turn on a playback switch, thus starting the playback operation. The speaker holes 78 generate a voice shown as, for example, a balloon in FIG. 13. Simultaneously, the image of a speaker related to this voice is displayed on the display. The image can be displayed until the playback of the voice related to the image is completed. As mentioned above, it is a matter of course that the image can be displayed for a predetermined period after the playback is started.

If it is not necessary to confirm an image, image display can be completely omitted. If any image related to a sound is not recorded, information (a recording time, a playback elapsed time, a recording mode (standard/long), and a file number) in the normal playback mode is displayed.

In the audio recording and playback device with the above-mentioned structure according to the embodiment of the present invention, even when the user executes the playback operation while selecting an image file (folder), a beep sound is generated as shown in FIG. 3 by the control of the system control unit 30. Consequently, any misoperation can be prevented.

Further, as shown in FIGS. 3 and 4, immediately after power-on reset, or just after hold release, an audio folder is automatically selected and displayed. Therefore, the possibility of the misoperation can be reduced.

Furthermore, upon playback, the operator can visually confirm a speaker while listening their speech. Particularly, in the case of interviews, for example, when the speech contents of a plurality of speakers are recorded so as to correspond to the respective speakers in order to form a documentary later, the device is effectively used.

Further, both of image data and audio data are stored in the nonvolatile memory. Accordingly, the cost is not increased. Since the imaging lens is arranged so that the shooting direction is the same as the pointing direction of the microphone, the operator can smoothly capture images upon recording without uncomfortable feelings and hardly gives a disagreeable impression to the speaker.

In this invention, it is apparent that working modes different in a wide range can be formed on this basis of this invention without departing from the spirit and scope of the invention. This invention is not restricted by any specific embodiment except being limited by the appended claims.

What is claimed is:

1. An audio recording and playback device comprising:
storage means having an audio storage area in which audio data is recorded and an image storage area in which image data is recorded;
first selection means for selecting the audio storage area or the image area;
second selection means for selecting audio data or image data stored in the storage means;
a playback instruction member for instructing playback of the audio data or image data selected by the second selection means;
audio playback means for playing back the audio data selected by the second selection means;
display means for playing back and displaying the image data selected by the second selection means; and
control means for controlling so that the audio data selected by the second selection means is played back and an image related to the audio data selected by the second selection means is played back when the playback instruction member is operated during the selection of the audio storage area by the first selection means, and controlling so that only the image data selected by the second selection means is played back when the playback instruction member is operated during the selection of the image storage area by the first selection means.

2. The audio recording and playback device according to claim 1, wherein
the first selection means automatically selects the audio storage area immediately after turn-on or just after a hold function is released.

3. An audio recording and playback device comprising:
storage means having an audio storage area in which audio data is stored and an image storage area in which image data is recorded;
first selection means for selecting the audio storage area or the image area;
second selection means for selecting audio data or image data stored in the storage means;
a playback instruction member for instructing playback of the audio data selected by the second selection means;
audio playback means for playing back the audio data selected by the second selection means;
warning means for warning that playback of audio data is forbidden; and
control means for controlling so that the audio data selected by the second selection means is played back when the playback instruction member is operated during the selection of the audio storage area by the first selection means, and controlling so that playback of the audio data stored in the storage means is forbidden and warning is performed when the playback instruction member is operated during the selection of the image storage area by the first selection means.

4. The audio recording and playback device according to claim 3, wherein
the first selection means automatically selects the audio storage area immediately after turn-on or just after a hold function is released.

5. An audio recording and playback device comprising:
storage means having an audio folder to store a plurality of audio data and an image folder to store a plurality of image data;
folder selection means for selecting the audio folder or the image folder;
data selection means for selecting audio data to be played back among the audio data stored in the audio folder or image data to be played back among the image data stored in the image folder, the folder being selected by the folder selection means;
display means for displaying attribute information of the audio data or the image data selected by the data selection means;
playback instruction means for instructing playback of the audio data selected by the data selection means when the audio folder is selected by the folder selection means;
audio playback means for playing back the audio data designated by the playback instruction means;
forbidding means for forbidding playback of audio data when the image folder is selected by the folder selection means; and
image playback means for playing back the image data selected by the data selection means when the playback instruction means is operated during the selection of the image folder by the folder selection means.

6. An audio recording and playback device comprising:
storage means having an audio folder to store a plurality of audio data and an image folder to store a plurality of image data;
folder selection means for selecting the audio folder or the image folder;
data selection means for selecting audio data to be played back among the audio data stored in the audio folder or image data to be played back among the image data stored in the image folder, the folder being selected by the folder selection means;
display means for displaying attribute information of the audio data or the image data selected by the data selection means;
playback instruction means for instructing playback of the audio data selected by the data selection means when the audio folder is selected by the folder selection means;
audio playback means for playing back the audio data designated by the playback instruction means;
forbidding means for forbidding playback of audio data when the image folder is selected by the folder selection means; and
warning means for warning when the playback instruction means is operated during the selection of the image folder by the folder selection means.
